(19) United States
(12) Patent Application Publication
(10) Pub. No.: US 2026/0338120 A1
(43) Pub. Date: Oct. 29, 2026

(54) STATE RECOVERY CONTROL METHOD FOR GAS TURBINES BASED ON STATE ASSESSMENT

(71) Applicant: Harbin Engineering University, Harbin (CN)

(72) Inventors: Yunpeng CAO, Harbin (CN); Xiaoyu HAN, Harbin (CN); Weixing FENG, Harbin (CN)

(73) Assignee: Harbin Engineering University, Harbin (CN)

(21) Appl. No.: 19/412,886

(22) Filed: Dec. 9, 2025

Related U.S. Application Data
(63) Continuation of application No. PCT/CN2025/127217, filed on Oct. 13, 2025.

(30) Foreign Application Priority Data
Dec. 9, 2024 (CN) 2024117963541

(51) Int. Cl. F02C 9/00; G05B 13/04

(52) U.S. Cl. CPC F02C 9/00; G05B 13/04; F05D 2260/81; F05D 2270/20

(57) ABSTRACT

A state recovery control method for gas turbines based on state assessment is disclosed, including: step S1, collecting external environmental parameters and monitoring parameters of a gas turbine; step S2, establishing a simulation twin model of the gas turbine by synchronizing parameters of a physical entity of the gas turbine; step S3, assessing an operation state of the gas turbine from a parameter level, a component level, and an equipment level; step S4, running the simulation twin model, inputting the external environmental parameters and corresponding monitoring parameters to the simulation twin model, setting an objective function, and adjusting internal performance parameters of the simulation twin model to synchronize with the physical entity; and step S5, performing operation state recovery control, selecting input control parameters of the gas turbine, and obtaining an optimal input control amount through the optimization algorithm to recover the operation state of the gas turbine.

### CROSS-REFERENCE TO RELATED APPLICATIONS

The application claims priority to Chinese patent application No. 2024117963541, filed on Dec. 9, 2024, the entire contents of which are incorporated herein by reference.

### TECHNICAL FIELD

The present disclosure relates to the field of gas turbine technology, and more particularly, to a state recovery control method for gas turbines based on state assessment.

### BACKGROUND

Gas turbines are widely used in fields such as power generation, aviation, and industrial drive systems. Performances and reliabilities of the gas turbines are crucial to an overall efficiency of these systems. However, during long-term operation, the gas turbines may experience performance degradation or failures due to various factors. Traditional maintenance and control methods of the gas turbines primarily rely on periodic inspections and empirical judgment, which fail to reflect the actual real-time operational states of the gas turbines, resulting in high maintenance costs, slow fault response, and low operating efficiency.

To enhance the operational efficiency and reliability of the gas turbines, there is an urgent need for a recovery control method based on real-time state assessment. By conducting a real-time assessment of various components of the gas turbine and the overall state of the gas turbine, and comprehensively considering external environmental conditions, operational parameters, and historical data, input control parameters can be selected and optimized, achieving real-time monitoring and intelligent control of the gas turbine, ensuring that the gas turbine can recover to and maintain in an optimal operation state under the premises of economic efficiency, easy operation, and environmental compliance.

### SUMMARY

The purpose of the present disclosure is to provide a state recovery control method for gas turbines based on state assessment, which achieves real-time monitoring and intelligent control of the gas turbine through real-time assessment of various components of the gas turbine and an overall state of the gas turbine, ensuring that the gas turbine can recover to and maintain in an optimal operation state under the premises of economic efficiency, easy operation, and environmental compliance.

The purpose of the present disclosure is achieved through the following technical solutions:

A state recovery control method for gas turbines based on state assessment, including the following steps:
step S1, collecting external environmental parameters and monitoring parameters of a gas turbine;
step S2, establishing a simulation twin model of the gas turbine by synchronizing parameters of a physical entity of the gas turbine;
step S3, based on an analytic hierarchy process, assessing an operation state of the gas turbine by numerically quantifying an operation state of the physical entity of the gas turbine from a parameter level, a component level, and an equipment level;
step S4, running the simulation twin model of the gas turbine, inputting the external environmental parameters and corresponding monitoring parameters to the simulation twin model, setting an objective function based on the monitoring parameters, and adjusting internal performance parameters of the simulation twin model through an optimization algorithm to synchronize with the physical entity of the gas turbine;
Step S5, performing operation state recovery control, selecting input control parameters of the gas turbine, and in the event of abnormal operation of the gas turbine, obtaining an optimal input control amount through the optimization algorithm to recover the operation state of the gas turbine;
in step S1, the external environmental parameters of the gas turbine include an ambient temperature, an ambient pressure, and a rotational speed; and the monitoring parameters include a compressor inlet temperature, a compressor inlet pressure, a turbine outlet pressure, a turbine outlet temperature, and a fuel flow rate;
in step S3, the assessment of the operation state of the gas turbine from the parameter level includes: establishing a monitoring parameter reference model and calculating normal values of the monitoring parameters under different states through regression prediction; calculating deviations between the normal values and actual values, and calculating a threshold interval for the monitoring parameters through a probability density statistics method; and converting a state assessment result of each monitoring parameter to be a number within a range of 0 to 1 through a membership function; the parameter assessment result is calculated as follows:

$$y = \{ \begin{matrix}0.1 , x < a \\ \begin{matrix}\frac{0.8}{b - a} \cdot x + \frac{0.1 b - 0.9 a}{b - a} , a \leq x < b \\ \frac{0.09}{c - b} \cdot x + \frac{0.9 c - 0.99 b}{c - b} , b \leq x < c \\ \frac{0.09}{c - d} \cdot x + \frac{0.9 c - 0.99 d}{c - d} , c \leq x < d \\ \frac{0.8}{d - e} \cdot x + \frac{0.1 d - 0.9 e}{d - e} , d \leq x < e \\ 0.1 , x \geq e\end{matrix}\end{matrix}$$

wherein, values of a and e are respectively a lower fault threshold and an upper fault threshold of the parameter, values of b and e are respectively a lower abnormality threshold and an upper abnormality threshold, and c is a reference value obtained by the monitoring parameter reference model.
in the assessment of the operation state of the gas turbine from the component level in the step S3, the state assessment result of each component is calculated using a radar chart method, in which an area of a polygon represents a current state of the component,
assuming distances from each vertex to a center point of the polygon are respectively r₁, r₂, . . . rₙ, and an angle of each vertex is 2π/n radians, the radar chart is calculated as follows:

$${S}_{1} = {\sum }_{i = 1}^{n - 1} \frac{1}{2} \times {r}_{i} \times {r}_{i + 1} \times sin ( \frac{2 π}{n} )$$

$${A}_{comp} = \frac{{S}_{1}}{{S}_{max}}$$

wherein, n is a number of the vertices, which is the number of the monitoring parameters contained in each component; rₙ is the distance from the corresponding vertex to the center point, which is the assessment result of each monitoring parameter; S₁ is an area of the polygon of the current component; Smax is the area of the polygon of the component in the best theoretical state; and A_{comp} is the state assessment result of each component;
in the assessment of the operation state of the gas turbine from the equipment level in step S3 the state assessment result of each component is integrated through a Bayesian network to evaluate the overall state of the equipment. For each node Xi in the Bayesian network, a joint probability density distribution can be expressed as:

$$P ( {X}_{1} , {X}_{2} , … , {X}_{n} ) = {∐}_{i = 1}^{n} P ( {X}_{i} \vert P a ( {X}_{i} ) )$$

wherein, Xi represents an i-th node, which includes the gas turbine and all the components that need to be evaluated; Pa (Xi) represents a set of parent nodes of Xi;
the internal performance parameters in step S4 refer to internal calculation parameters of the simulation twin model of the gas turbine, which include a flow correction factor, a total pressure recovery coefficient correction factor, and an efficiency correction factor;
In step S4, the setting an objective function based on the monitoring parameters, and adjusting internal performance parameters of the simulation twin model through an optimization algorithm to synchronize with the physical entity of the gas turbine includes:
collecting the monitoring parameters of the gas turbine through sensors, including a speed, a power, an exhaust temperature, and a compressor outlet pressure; calculating an error cᵢ for each target monitoring parameter, which is represented by a simulated value yᵢ′ of the simulation twin model and an actual operating parameter value yᵢ of the gas turbine as follows:

$${c}_{i} = \frac{{y}_{i}^{′} - {y}_{i}}{{y}_{i}} \times 100 \% ;$$

describing the process of establishing the simulation twin model of the gas turbine as an optimization problem of solving performance parameters of a set of components to minimize the calculated error of each target monitoring parameter; defining the objective function as a function for calculating the error for each selected target monitoring parameter:

$$min f ( x ) = min \sqrt{\{ {\sum }_{i = 1}^{m} {{w}_{i} [ ( {y}_{i}^{′} - {y}_{i} ) / {y}_{i} ]}^{2} \} / m}$$

x={x₁,x₂, . . . ,xᵢ, . . . ,xₙ}

s.t. x_{k,min}≤x≤x_{k,max} k=1,2,3, . . . ,n
wherein m is a number of the target monitoring parameters; wᵢ is a weighted coefficient for each target monitoring parameter and

$${\sum }_{i = 1}^{m} {w}_{i}$$

=1; n is a number of performance parameters; xᵢ is the performance parameter; x_{k,max} and x_{k,min} are respectively an upper limit and a lower limit of a corresponding performance parameter correction factor;
the optimization algorithm includes: adopting a particle swarm optimization algorithm based on particle exclusion zone and Levy flight, balancing traditional PSO updates and Levy flight updates through a probability mechanism, setting the particle exclusion zone to redistribute particles, reassigning the particles initially located in the exclusion zone to the position of the previous particle, and retaining the position of the particles entering the exclusion zone from the previous iteration in the iteration process;
in step S5, the input control parameters of the gas turbine are selected by, based on the state recovery control of the gas turbine, comprehensively considering the state assessment results of each component, environmental conditions, operating conditions, historical data, economy, operability, and environmental compliance; by selecting appropriate input control parameters, the gas turbine can resume normal operation under the premises of being economically efficient, operationally simple, and environmentally compliant. can be ensured;
in step S5, the in the event of abnormal operation of the gas turbine, obtaining an optimal input control amount through the optimization algorithm to recover the operation state of the gas turbine includes:
adjusting the input control amount to achieve a maximum assessment result of the operation state of the gas turbine as follows:

Obj=min{1−Assessment[gasturbin(ΔIN₁,ΔIN₂, . . . ,ΔINₙ)]};
wherein, gasturbin represents the simulation twin model of the gas turbine, with an input being the input control amount of the gas turbine, an output being the real-time monitoring parameters of the gas turbine; Assessment represents an operation state assessment model, with an input being the monitoring parameters of the gas turbine, and an output being a current state assessment result of the gas turbine; and ΔINₙ is the input control amount.

The beneficial effects of the present disclosure are:
The simulation twin model of the gas turbine established by the volumetric inertia method introduces a performance degradation mechanism and a fault factor to achieve a simulation of the performance degradation and fault of the gas turbine. The internal performance parameters of the simulation twin model are adjusted through the optimization algorithm to synchronize with the physical entity of the gas turbine, achieving a combination of virtual and real, and enhancing the practicality and reliability of the simulation model. The twin mechanism fully considers the direct reflection of performance parameters on the operation state of the gas turbine. The state assessment is conducted at three levels: the parameter level, the component level, and the equipment level, delving deeper and comprehensively covering all aspects of the gas turbine to ensure the comprehensiveness and reliability of the assessment results. The control recovery parameters of the gas turbine are determined. In the event of abnormal operation of the gas turbine, the input control amount is taken as the independent variable, and the state assessment result is taken as the dependent variable. The optimal input control amount is solved through the optimization algorithm to achieve the target optimization of the operation state of the gas turbine.

### BRIEF DESCRIPTION OF DRAWINGS

The present disclosure will be further described in detail with reference to the accompanying drawings and specific implementation methods.

FIG. 1 is a schematic diagram showing a state recovery control method for gas turbines based on state assessment according to an embodiment of the present disclosure;

FIG. 2 is a flowchart of the recovery control method for gas turbines based on state assessment according to an embodiment of the present disclosure; and

FIG. 3 is a schematic diagram showing the state recovery result of the gas turbine of the present disclosure.

### DETAILED DESCRIPTION OF THE EMBODIMENTS

The present disclosure will be further described in detail with reference to the accompanying drawings.

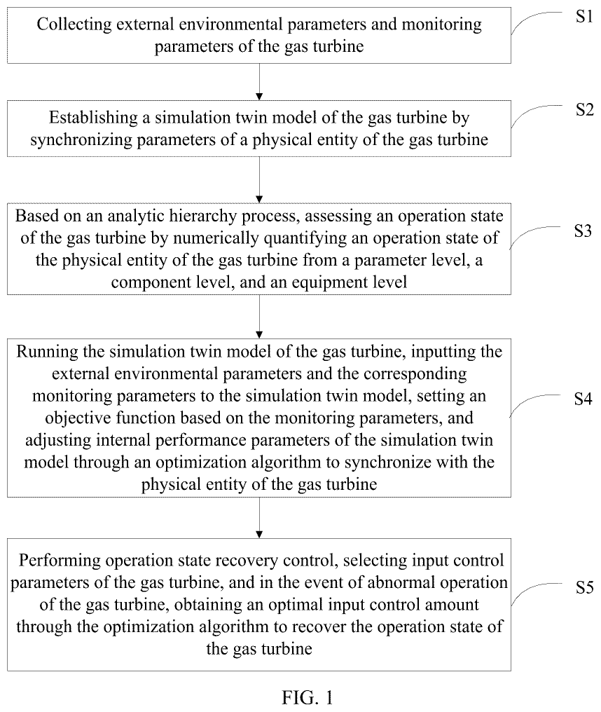

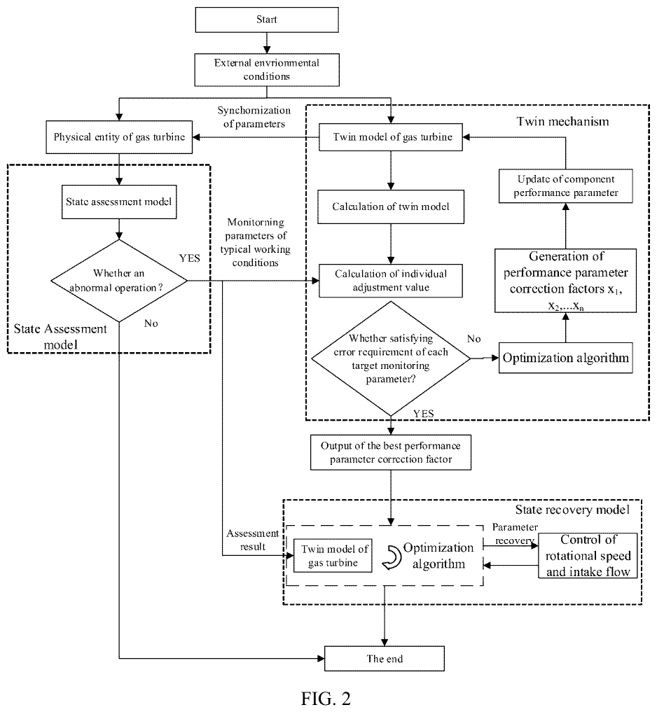

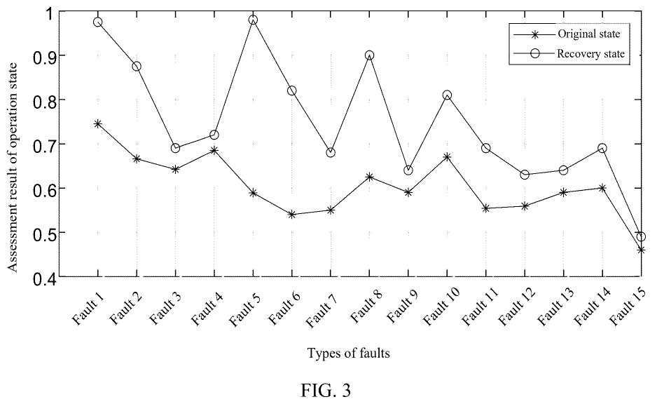

As shown in FIGS. 1 to 3, in order to achieve the technical effect of realizing real-time monitoring and intelligent control of a gas turbine through real-time assessment of various components of the gas turbine and the overall state of the gas turbine, ensuring that the gas turbine can recover to and maintain in an optimal operation state under the premises of economic efficiency, operational simplicity, and environmental compliance, a state recovery control method for gas turbines based on state assessment is provided, with steps and functions thereof being described in detail below.

As shown in FIG. 1, the state recovery control method for gas turbines based on state assessment is provided, including steps as follows.
Step S1, collecting external environmental parameters and monitoring parameters of the gas turbine.

In an embodiment, the external environmental parameters and the monitoring parameters of the gas turbine are dynamically collected through a gas turbine control system acquisition unit and sensors installed on the gas turbine.

Taking a certain type of three-axis gas turbines as an example, the collected external environmental parameters and monitoring parameters may include: an ambient temperature, an ambient pressure, a low-pressure compressor inlet temperature, a low-pressure compressor inlet pressure, a low-pressure compressor outlet temperature, a low-pressure compressor outlet pressure, a high-pressure compressor outlet temperature, a high-pressure compressor outlet pressure, a low-pressure turbine outlet temperature, a low-pressure turbine outlet temperature, a power turbine outlet temperature, a power turbine outlet pressure, a low-pressure turbine speed, a high-pressure turbine speed, a power turbine speed, a fuel flow rate, and a throttle opening, etc.
Step S2, establishing a simulation twin model of the gas turbine by synchronizing parameters of a physical entity of the gas turbine.

In an embodiment, the simulation model of the gas turbine is established using a volumetric inertia method. Taking gas path components of a certain type of three-axis gas turbine as an example, the parameters of the physical entity of the gas turbine may include a low-pressure compressor, a high-pressure compressor, combustion chamber, a high-pressure turbine, a low-pressure turbine, and a power turbine, etc.
Step S3, based on an analytic hierarchy process, assessing an operation state of the gas turbine by numerically quantifying an operation state of the physical entity of the gas turbine from a parameter level, a component level, and an equipment level.

In an embodiment, a monitoring parameter reference model is established through a long short-term memory (LSTM) network. Input parameters of the monitoring parameter reference model include an ambient temperature, an ambient pressure, and a calculated torque. Normal values of the monitoring parameters under different states are calculated using a regression prediction method based on LSTM.

In an embodiment, the parameters are normalized using a maximum and minimum value method in specific examples. x^{i,j} represents raw data,

$${x}_{n o r m}^{i , j}$$

represents an i-th normalized value of a parameter j.

$${x}_{max}^{j}$$

and

$${x}_{min}^{j}$$

are respectively a maximum value and a minimum value of the parameter j. The data is normalized to be in a range of [0, 1] through data pre-processing, reducing the impact of operating conditions and environment.

$${x}_{norm}^{i , j} = \frac{{x}^{i , j} - {x}_{min}^{j}}{{x}_{max}^{j} - {x}_{min}^{j}} .$$

In an embodiment, historical data of a specified window size is input for prediction. A window length is set to be n. Thus, the constructed two-dimensional input dimension for the three input parameters is (3, n), and the corresponding output dimension is (1, p), which means using n steps of historical data to predict the trend after p steps, wherein n=3 and p=1. The three constructed input parameters are input into the LSTM model to train the monitoring parameter reference model for predicting the reference value for the next one step.

In an embodiment, the monitoring parameter reference model includes two LSTM layers and one fully-connected layer. Time series features of a low-pressure turbine exhaust temperature are extracted in a LSTM hidden layer, and then the regression from these features to predicted values is performed through the fully-connected layer. The model utilizes a tanh activation function, L2 regularization (coefficient 0.001), an Adam optimizer (learning rate 0.01), and a mean squared error (mse) loss function. The model is trained for 300 iterations.

In an embodiment, a threshold interval for the monitoring parameters is calculated through kernel density estimation. The threshold interval can be determined through a confidence interval, wherein an upper abnormality threshold and a lower abnormality threshold are set at the 95% confidence interval, while an upper fault threshold and a lower fault threshold are set at the 99% confidence interval.

In an embodiment, a parameter assessment result is converted into a certain number within the range of 0 to 1 through a membership function. The selection of the membership function refers to a trapezoidal membership function and a triangular membership function. The specific calculation formula is as follows, and the state assessment result from the parameter level is calculated.

$$y = \{ \begin{matrix}0.1 , & x < a \\ \frac{0.8}{b - a} \cdot x + \frac{0.1 b - 0.9 a}{b - a} , & a \leq x < b \\ \frac{0.09}{c - b} \cdot x + \frac{0.9 c - 0.99 b}{c - b} , & b \leq x < c \\ \frac{0.09}{c - b} \cdot x + \frac{0.9 c - 0.99 d}{c - d} , & c \leq x < d \\ \frac{0.8}{d - e} \cdot x + \frac{0.1 d - 0.9 e}{d - e} , & d \leq x < e \\ 0.1 , & x \geq e\end{matrix}$$

Wherein, values of a and e are respectively the lower fault threshold and the upper fault threshold of the parameter, values of b and e are respectively the lower abnormality threshold and the upper abnormality threshold, and c is the reference value obtained by the monitoring parameter reference model.

In an embodiment, the gas turbine includes four components, represented as four vertices of a radar chart. Distances from each vertex to a center point are r₁, r₂, r₃, r₄, and an angle of each vertex is 90 degrees. The radar chart is calculated as follows.

$${S}_{1} = \frac{1}{2} \times sin \frac{Π}{2} \times ( {r}_{1} \times {r}_{2} + {r}_{2} \times {r}_{3} + {r}_{3} \times {r}_{4} + {r}_{4} \times {r}_{1} )$$

In an embodiment, the gas turbine includes four components: a gas path, a fuel system, a lubricating oil system, and a cooling system. Therefore, the Bayesian network includes five nodes, and a joint probability density distribution of the Bayesian network can be expressed as:

P(T,G,O,F,C)=P(T|G,O,F,C)·P(G)·P(O)·P(F)·P(C)

Wherein, T represents the gas turbine, and G, O, F, and C respectively represent the four components of the gas turbine; namely, the gas path, the fuel system, the lubricating oil system, and the cooling system of the gas turbine.
Step S4, running the simulation twin model of the gas turbine, inputting the external environmental parameters and the corresponding monitoring parameters to the simulation twin model, setting an objective function based on the monitoring parameters, and adjusting internal performance parameters of the simulation twin model through an optimization algorithm to synchronize with the physical entity of the gas turbine.

In an embodiment, taking the gas path as an example, the internal performance parameters include a low-pressure compressor flow correction factor, a low-pressure compressor efficiency correction factor, a high-pressure compressor flow correction factor, a high-pressure compressor efficiency correction factor, a combustion chamber total pressure recovery coefficient correction factor, a high-pressure turbine flow correction factor, a high-pressure turbine efficiency correction factor, a low-pressure turbine flow correction factor, a low-pressure turbine efficiency correction factor, a power turbine flow correction factor, and a power turbine efficiency correction factor.

In an embodiment, the optimization algorithm has a particle swarm size N of 30, an iteration number iter of 500, a search space dimension dim of 10, an inertia weight w of 0.7, a cognitive coefficient c1 of 1.2, a social coefficient c2 of 1.5, and a Levy flight step size RL of 0.15*Levy(N, dim, 1.5), wherein 1.5 is the β parameter of the Levy distribution.
Step S5, performing operation state recovery control, selecting input control parameters of the gas turbine, and in the event of abnormal operation of the gas turbine, obtaining an optimal input control amount through the optimization algorithm to recover the operation state of the gas turbine.

In an embodiment, the step S5 includes adjusting the input control amount to achieve a maximum assessment result of the operation state of the gas turbine as follows:

Obj=min{1−Assessment[gasturbin(ΔIN₁,ΔIN₂, . . . ,ΔINₙ)]}

Wherein, gasturbine represents the simulation twin model of the gas turbine, with an input being the input control amount of the gas turbine and an output being the real-time monitoring parameters of the gas turbine; Assessment represents an operation state assessment model, with an input being the monitoring parameters of the gas turbine and an output being the current assessment result of the gas turbine state; and ΔINₙ represents an input control amount.

In an embodiment, a control rotational speed and an intake flow rate are selected as the input control amount.

In an embodiment, since a rotational speed of a power turbine of the gas turbine ranges from 3000 r/min to 3600 r/min, an upper limit and a lower limit for the change of the control rotational speed parameter of the gas turbine are determined to be [−600, 600] r/min. Due to the constraints of adjustable guide vanes, the change in the intake flow rate is controlled to be within 10%. At the 0.95 operating condition, where the intake flow rate is approximately 80 kg/s, it is accordingly determined that an upper limit and a lower limit for the change of the intake flow rate parameter are [−6, 6] kg/s.

In an embodiment, the recovery states that can be achieved under different faults are also different. Wherein, Fault 5 demonstrates the best recovery effect, with a health index increasing from an initial state of 0.5846 to 0.9795. In contrast, Fault 15 shows the poorest recovery effect, with the health index only slightly improving from an initial state of 0.4602 to 0.4921, only slightly improving the performance of the gas turbine. Overall, the recovery results under various states show improvement.

In an embodiment, the optimized input control amount is shown in the following table:

TABLE 5.3
Fault State Input Control Amounts

| Fault | Control rotational | Intake flow |
|---|---|---|
| number | speed n | rate G_{f0} |
| F1 | −102.265 | 2.423 |
| F2 | 597 | 1.065 |
| F3 | 592 | −0.262 |
| F4 | 245.325 | 0.654 |
| F5 | 542.652 | 1.213 |
| F6 | 600 | 3.097 |
| F7 | −455.358 | 2.635 |
| F8 | 600 | 1.201 |
| F9 | 600 | 0.879 |
| F10 | 143.555 | 1.798 |
| F11 | 600 | 2.003 |
| F12 | −600 | 2.112 |
| F13 | −52.631 | 0.429 |
| F14 | −600 | 0.372 |
| F15 | −162.332 | 2.541 |

It should be noted that the steps shown in the above process or the flowchart in the attached figure can be executed in a computer system such as a set of computer executable instructions, and although the logical order is shown in the flowchart, in some cases, the steps shown or described may be executed in a different order than here.

The above embodiments only express several embodiments of the present application, and their descriptions are more specific and detailed, but should not be understood as limiting the scope of the invention patent. It should be pointed out that for ordinary technical personnel in this field, several modifications and improvements can be made without departing from the concept of this application, which are within the scope of protection of this application. Therefore, the scope of protection of the present patent application should be based on the attached claims.

What is claimed is:

1. A state recovery control method for gas turbines based on state assessment, wherein the method comprises:
step S1, collecting external environmental parameters and monitoring parameters of a gas turbine;
step S2, establishing a simulation twin model of the gas turbine by synchronizing parameters of a physical entity of the gas turbine;
step S3, based on an analytic hierarchy process, assessing an operation state of the gas turbine by numerically quantifying an operation state of the physical entity of the gas turbine from a parameter level, a component level, and an equipment level;
step S4, running the simulation twin model of the gas turbine, inputting the external environmental parameters and corresponding monitoring parameters to the simulation twin model, setting an objective function based on the monitoring parameters, and adjusting internal performance parameters of the simulation twin model through an optimization algorithm to synchronize with the physical entity of the gas turbine;
in step S4, the setting an objective function based on the monitoring parameters, and adjusting internal performance parameters of the simulation twin model through an optimization algorithm to synchronize with the physical entity of the gas turbine comprises:
collecting the monitoring parameters of the gas turbine through sensors, comprising a rotational speed, a power, an exhaust temperature, and a compressor outlet pressure; calculating an error cᵢ for each target monitoring parameter, which is represented by a simulated value yᵢ′ of the simulation twin model and an actual operating parameter value yᵢ of the gas turbine as follows:
$${c}_{i} = \frac{{y}_{i}^{′} - {y}_{i}}{{y}_{i}} \times 1 \; 00 \% ;$$
describing the process of establishing the simulation twin model of the gas turbine as an optimization problem of solving performance parameters of a set of components to minimize the calculated error of each target monitoring parameter; defining the objective function as a function for calculating the error for each selected target monitoring parameter:
$$\begin{matrix}min f ( x ) = min \sqrt{\{ {\sum }_{i = 1}^{m} {w [ ( {y}_{i}^{′} - {y}_{i} ) / {y}_{i} ]}^{2} \} / m} \\ x = \{ {x}_{1} , {x}_{1} , … , {x}_{i} , … , {x}_{n} \}\end{matrix} ;$$
x={x₁,x₂, . . . ,xᵢ, . . . ,xₙ}
s.t. x_{k,min}≤x≤x_{k,max} k=1,2,3, . . . ,n
wherein m is a number of the target monitoring parameters; wᵢ is a weighted coefficient for each target monitoring parameter and
$${\sum }_{i = 1}^{m} {w}_{i} = 1 ;$$
n is a number of the performance parameters; xᵢ is the corresponding performance parameter; x_{k,max} and x_{k,min} are respectively an upper limit and a lower limit of a corresponding performance parameter correction factor;
step S5, performing operation state recovery control, selecting input control parameters of the gas turbine, and in the event of abnormal operation of the gas turbine, obtaining an optimal input control amount through the optimization algorithm to recover the operation state of the gas turbine;
in step S5, the in the event of abnormal operation of the gas turbine, obtaining an optimal input control amount through the optimization algorithm to recover the operation state of the gas turbine comprises:
adjusting the input control amount to achieve a maximum assessment result of the operation state of the gas turbine as follows:
Obj=min{1−Assessment[gasturbin(ΔIN₁,ΔIN₂, . . . ,ΔINₙ)]};
wherein, gasturbin represents the simulation twin model of the gas turbine, with an input being the input control amount of the gas turbine, an output being the real-time monitoring parameters of the gas turbine; Assessment represents an operation state assessment model, with an input being the monitoring parameters of the gas turbine, and an output being a current state assessment result of the gas turbine; and ΔINₙ is an input control variable.

2. The state recovery control method for gas turbines based on state assessment according to claim 1, wherein in step S1, the external environmental parameters of the gas turbine comprise an ambient temperature, an ambient pressure, and a rotational speed; and the monitoring parameters comprise a compressor inlet temperature, a compressor inlet pressure, a turbine outlet pressure, a turbine outlet temperature, and a fuel flow rate.

3. The state recovery control method for gas turbines based on state assessment according to claim 1, wherein the simulation twin model of the gas turbine in step S2 is established using a volumetric inertia method, and a performance degradation mechanism and a fault factor are introduced to achieve a simulation of performance degradation and fault of the gas turbine.

4. The state recovery control method for gas turbines based on state assessment according to claim 1, wherein in step S3, the assessment of the operation state of the gas turbine from the parameter level comprises:
establishing a monitoring parameter reference model and calculating normal values of the monitoring parameters under different states through regression prediction;
calculating deviations between the normal values and actual values, and calculating threshold intervals for the monitoring parameters through probability density statistics; and
calculating a state assessment result of each monitoring parameter through a membership function.

5. The state recovery control method for gas turbines based on state assessment according to claim 1, wherein in the assessment of the operation state of the gas turbine from the component level in step S3, a state assessment result of each component is calculated using a radar chart method, in which an area of a polygon represents a current state of the component;
assuming distances from each vertex to a center point of the polygon are respectively r₁, r₂, . . . rₙ, and an angle of each vertex is 2π/n radians, the radar chart is calculated as follows:
$${S}_{1} = {\sum }_{i = 1}^{n - 1} \frac{1}{2} \times {r}_{i} \times {r}_{i + 1} \times sin ( \frac{2 π}{n} )$$
$${A}_{c o m p} = \frac{{S}_{1}}{{S}_{max}} ;$$
wherein, n is a number of the vertices, which is the number of the monitoring parameters contained in each component; rₙ is the distance from the corresponding vertex to the center point, which is the assessment result of each monitoring parameter; S₁ is an area of the polygon of the current component; Smax is the area of the polygon of the component in the best theoretical state; and A_{comp} is the state assessment result of each component.

6. The state recovery control method for gas turbines based on state assessment according to claim 1, wherein in the assessment of the operation state of the gas turbine from the equipment level in step S3, the state assessment result of each component is integrated through a Bayesian network to assess an overall state of the equipment.

7. The state recovery control method for gas turbines based on state assessment according to claim 1, wherein the internal performance parameters in step S4 refer to internal calculation parameters of the simulation twin model of the gas turbine, and comprise a flow correction factor, a total pressure recovery coefficient correction factor, and an efficiency correction factor.

8. The state recovery control method for gas turbines based on state assessment according to claim 1, wherein in step S5, the input control parameters of the gas turbine are selected by, based on the state recovery control of the gas turbine, comprehensively considering the state assessment results of each component, environmental conditions, operating conditions, historical data, economy, operability, and environmental compliance.
